(19) United States
(12) Patent Application Publication
(10) Pub. No.: US 2026/0092888 A1
(43) Pub. Date: Apr. 2, 2026

(54) METHOD FOR PREPARING BIOLOGICAL DETECTION COMPONENT AND BIOLOGICAL DETECTION COMPONENT

(71) Applicant: National Taiwan Normal University, TAIPEI CITY (TW)

(72) Inventors: TIEN-LI CHANG, TAIPEI CITY (TW); QI-XUAN WU, TAIPEI CITY (TW); SONG-PU HUANG, TAIPEI CITY (TW); YUAN-JUN CHEN, TAIPEI CITY (TW)

(21) Appl. No.: 18/987,238

(22) Filed: Dec. 19, 2024

(30) Foreign Application Priority Data
Sep. 30, 2024 (TW) 113137199

(51) Int. Cl. G01N 27/327

(52) U.S. Cl. CPC G01N 27/3278

(57) ABSTRACT

A method for preparing a biological detection component and a biological detection component are provided. The method includes forming a composite material film layer on a substrate, in which the composite material film layer contains graphene oxide and a metal oxide. The metal oxide in the composite material film layer has a first crystal phase, and the first crystal phase is an anatase phase. The method further includes inducing a crystal phase transformation on the surface of the composite material film layer using an ultrafast laser, such that the metal oxide is at least partially transformed from the first crystal phase to a second crystal phase, and the graphene oxide is reduced to reduced graphene oxide, thereby forming a surface modification structure on the substrate, in which the second crystal phase is a rutile phase.

### CROSS-REFERENCE TO RELATED PATENT APPLICATION

This application claims the benefit of priority to Taiwan Patent Application No. 113137199, filed on Sep. 30, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a laser processing method, and more particularly to a method for preparing a biological detection component by inducing crystal phase transformation using an ultrafast laser, and a biological detection component.

### BACKGROUND OF THE DISCLOSURE

Titanium dioxide (TiO₂) materials are widely used in fields such as biosensing and environmental monitoring due to excellent photocatalytic properties and stability.

In the related art, crystal phase transformation of titanium dioxide usually involves conventional methods, such as chemical deposition and heat treatment. However, the conventional methods have drawbacks such as high energy consumption, complex processes, structural damage, and uneven transformation.

For example, the heat treatment requires a high processing temperature (usually exceeding 600° C.), leading to high energy consumption and causing damage to the material, which can affect how well the material performs. Such technical problems can limit the efficiency of the conventional methods in large-scale applications, especially in the preparation of biological detection components that require high sensitivity and high stability.

### SUMMARY OF THE DISCLOSURE

In response to the above-referenced technical inadequacies, the present disclosure provides a biological detection component by inducing crystal phase transformation using an ultrafast laser, and further provides a biological detection component.

In one aspect, the present disclosure provides a method for preparing a biological detection component that includes a film layer formation step and a surface modification step. The film layer formation step includes forming a composite material film layer on a substrate, in which the composite material film layer includes graphene oxide and a metal oxide, the metal oxide in the composite material film layer has a first crystal phase, and the first crystal phase is an anatase phase. The surface modification step includes inducing a crystal phase transformation on a surface of the composite material film layer using an ultrafast laser, such that the metal oxide is at least partially transformed to a second crystal phase from the first crystal phase, and the graphene oxide is reduced to reduced graphene oxide, thereby forming a surface modification structure on the substrate to prepare the biological detection component. The second crystal phase is a rutile phase.

In another aspect, the present disclosure provides a biological detection component that includes a substrate and a surface modification structure. The surface modification structure is formed on the substrate. The surface modification structure includes a metal oxide and reduced graphene oxide, the metal oxide has a first crystal phase and a second crystal phase, the first crystal phase is an anatase phase, and the second crystal phase is a rutile phase.

Therefore, the method for preparing the biological detection component of the present disclosure includes using the ultrafast laser to perform surface modification on the composite material that contains graphene oxide and metal oxide, and transforming the anatase phase into the rutile phase. The method of the present disclosure has good potential for being applied in the preparation of wearable biological detection components and other nanostructures, offering high sensitivity and high stability.

Furthermore, the method utilizing the ultrafast laser has advantages of fast processing speed and high precision, which can significantly improve production efficiency and reduce production costs.

The method for preparing the biological detection component of the present disclosure can achieve surface modification and crystal phase transformation of materials in a short time, avoiding the cumbersome heating and cooling processes in conventional methods.

Additionally, the method provided by the present disclosure is environmentally friendly, does not involve the use of harmful chemicals, and meets recent industrial requirements for environmental protection.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A and FIG. 1B are schematic flow diagrams of a method for preparing a biological detection component according to a first embodiment of the present disclosure;

FIG. 2 is a schematic view of the biological detection component and a detection step using the biological detection component according to the first embodiment of the present disclosure;

FIG. 3A, FIG. 3B, FIG. 3C, FIG. 3D, FIG. 3E and FIG. 3F show surface morphology photographs of different materials under scanning electron microscope (SEM) according to the first embodiment of the present disclosure;

FIG. 4A, FIG. 4B, FIG. 4C, FIG. 4D, FIG. 4E and FIG. 4F show particle size distributions of titanium dioxide particles of the different materials;

FIG. 5A shows X-ray diffraction spectra of the different materials;

FIG. 5B shows Raman spectra of the different materials;

FIG. 6 shows UV-visible absorption spectra of the different materials;

FIG. 7A shows relationships between width and depth at different laser energy densities;

FIG. 7B shows effects of natural logarithm of energy densities on ablation areas;

FIG. 8 is a schematic view of an electrode pattern according to a second embodiment of the present disclosure; and

FIG. 9A is CV curves of the different materials in 1 M KOH aqueous solution at a scan rate of 200 mVs⁻¹ under steady-state conditions;

FIG. 9B shows the detection of LA (lactic acid), GL (glucose), and PBS using the L-TiO₂@GO composite film;

FIG. 9C shows the effect of different lactic acid concentrations on the different materials;

FIG. 9D shows the response value and sensitivity of the different material;

FIG. 9E shows the effect of different lactic acid concentrations on the different material with the electrode pattern; and

FIG. 9F shows the response value and sensitivity of the different material with the electrode pattern.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

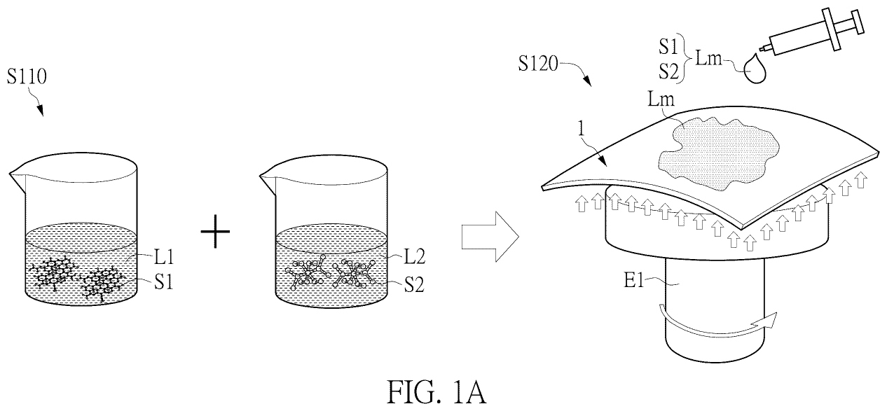

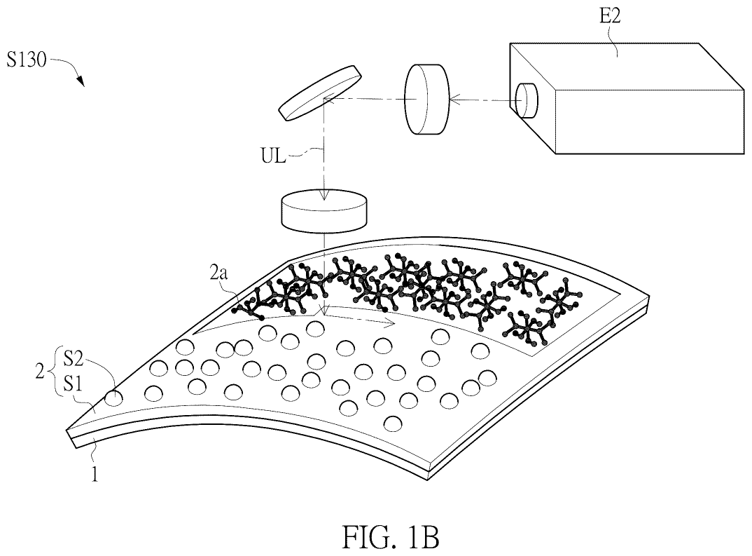

Referring to FIG. 1A and FIG. 1B, a first embodiment of the present disclosure provides a method for preparing a biological detection component (e.g., biosensor) by inducing crystal phase transformation using an ultrafast laser, which includes step S110, step S120, and step S130. It should be noted that sequence of steps and actual operation methods described in the present embodiment can be adjusted as needed and are not limited to those described in the present embodiment.

Step S110 is a solution preparation step, which includes mixing a first liquid L1 containing graphene oxide S1 (GO) and a second liquid L2 containing metal oxide S2 to form a mixed liquid Lm. That is, the mixed liquid Lm contains the graphene oxide S1 and the metal oxide S2.

More specifically, the first liquid L1 is a dispersed aqueous solution containing the graphene oxide S1. The second liquid L2 is a dispersed aqueous solution containing the metal oxide S2. The metal oxide S2 is titanium dioxide (TiO₂), but the present disclosure is not limited thereto. In the present embodiment, a content of the graphene oxide S1 in the first liquid L1 is 0.2 to 6 mg/ml (e.g., 1 mg/ml), and the graphene oxide S1 is in a sheet shape, which can be a single-layer sheet structure or a multi-layer sheet structure. The second liquid L2 can be formed by mixing, for example, 40 to 100 mg (e.g., 80 mg) of titanium dioxide powder with 10 to 50 ml (e.g., 30 ml) of an alcohol-containing aqueous solution (e.g., 40% to 50% ethanol aqueous solution). The mixed liquid Lm is formed by mixing the first liquid L1 (i.e., the dispersed aqueous solution containing the graphene oxide S1) and the second liquid L2 (i.e., the dispersed aqueous solution containing the metal oxide S2) at a volume ratio of 1:2 to 2:1.

Step S120 is a film layer formation step, which includes applying the mixed liquid Lm onto a substrate 1 to form a composite material film layer 2 containing the graphene oxide S1 and the metal oxide S2 on the substrate 1. The metal oxide S2 (e.g., titanium dioxide) has a first crystal phase, and the first crystal phase is an anatase phase.

In the present embodiment, for convenience of description, the composite material formed by mixing the graphene oxide S1 and the metal oxide S2 (e.g., titanium dioxide) is represented as TiO₂@GO, but the present disclosure is not limited thereto.

More specifically, the film layer formation step includes: placing the substrate 1 on a coating unit E1 (e.g., a spin coater), and applying the mixed liquid Lm containing the graphene oxide S1 and the metal oxide S2 onto the substrate 1 by titration. Then, through the rotation of the coating unit E1 and heating and drying the mixed liquid Lm, a composite material film layer 2 is formed on the substrate 1. The conditions for heating and drying can be, for example, baking the mixed liquid Lm at a heating temperature of 40° C. to 80° C. for 30 to 90 minutes to remove the liquid components from the graphene oxide S1 and the metal oxide S2, thereby forming the composite material film layer 2.

It is worth mentioning that, in the present embodiment, after drying, the graphene oxide S1 forms a continuous lamellar structure (e.g., continuous sheet-like structure) on the substrate 1, and the metal oxide S2 (e.g., titanium dioxide) is dispersed in granular form on the graphene oxide S1 having the continuous lamellar structure, but the present disclosure is not limited thereto.

Furthermore, the substrate 1 is a flexible polymer substrate, which facilitates the application of the prepared element in products requiring bending capabilities (e.g., wearable biosensors).

In some embodiments of the present disclosure, the substrate 1 can be a flexible polymer substrate, such as a polyimide (PI) substrate, a polyethylene (PE) substrate, a polydimethylsiloxane (PDMS) substrate, a polyethylene terephthalate (PET) substrate, a polyethylene naphthalate (PEN) substrate, a polyamide (PA) substrate, or a polycarbonate (PC) substrate. Preferably, the substrate 1 is a polyimide (PI) substrate, but the present disclosure is not limited thereto.

A thickness of the substrate 1 is between 60 micrometers and 90 micrometers, and preferably between 70 micrometers and 80 micrometers. Furthermore, a thickness of the composite material film layer 2 is between 1 micrometer and 10 micrometers, and preferably between 4 micrometers and 5 micrometers, but the present disclosure is not limited thereto.

Step S130 is a surface modification step, which includes inducing a crystal phase transformation on a surface of the composite material film layer 2 using an ultrafast laser UL emitted by a laser unit E2, such that the metal oxide S2 (e.g., titanium dioxide) in the composite material film layer 2 is at least partially transformed to a second crystal phase from the first crystal phase (i.e., the anatase phase), in which the second crystal phase is a rutile phase, and the graphene oxide (GO) is reduced to reduced graphene oxide (rGO).

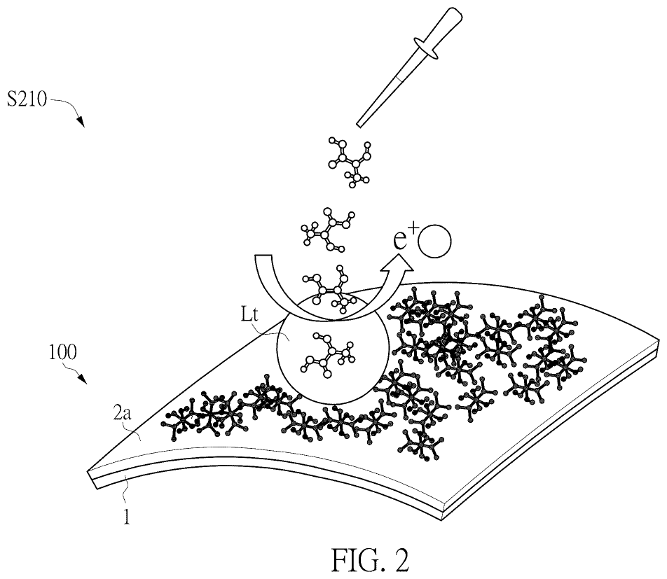

Accordingly, a surface modification structure 2a is finally formed on the substrate 1, thereby completing the preparation of a biological detection component 100 (as shown FIG. 2) that can be applied to biological detection (e.g., lactate detection). That is, the surface modification structure 2a has a dual-phase crystal structure composed of the first crystal phase (i.e., the anatase phase) and the second crystal phase (i.e., the rutile phase), and further has a structure mixed with reduced graphene oxide (rGO).

More specifically, a conductivity type of the reduced graphene oxide (rGO) is p-type, a conductivity type of the metal oxide (e.g., titanium dioxide) is n-type, and the surface modification structure 2a has a p-n heterojunction formed between the p-type reduced graphene oxide (rGO) and the n-type metal oxide (titanium dioxide). Accordingly, the sensing response sensitivity of the material can be increased.

Furthermore, the ultrafast laser UL refers to a laser light source with short pulse duration in a range of femtoseconds (fs, 10-15 seconds) to picoseconds (ps, 10-12 seconds).

In the present embodiment, the ultrafast laser UL is preferably a femtosecond laser. The laser processing conditions for surface modification of the surface of the composite material film layer 2 by the ultrafast laser UL include: a laser wavelength between 1,030 nm and 1,050 nm (preferably 1,040 nm), a maximum output power between 11 W and 13 W (preferably 12 W), and an energy density between 0.50 J/cm² and 0.75 J/cm² (preferably 0.61 J/cm²). Additionally, a theoretical spot diameter is between 13 μm and 17 μm (preferably 15 μm), a scanning speed is between 900 mm/s and 1,100 mm/s (preferably 1,000 mm/s), a repetition rate is between 90 kHz and 110 kHz (preferably 100 kHz), and a scanning area is 15 to 25 mm×15 to 25 mm (preferably 20 mm×20 mm). The above are the operating conditions under which the ultrafast laser UL can induce the crystal phase transformation of titanium dioxide on the surface of the composite material and reduce graphene oxide, but the present disclosure is not limited thereto.

According to the above configuration, the present disclosure proposes a method of surface modification of TiO₂@GO composite material using an ultrafast laser, which involves partially transforming titanium dioxide from the anatase phase to the rutile phase. The method has the advantages of high yield, environmental friendliness, and rapid processing. The biological detection component 100 prepared by the present disclosure forms a p-n heterojunction due to the mixed structure of p-type rGO and n-type TiO₂, enhancing the sensing response of the material.

The biological detection component 100 (e.g., biosensor) prepared by step S130 includes the substrate 1 (e.g., a flexible substrate) and the composite material film layer 2 formed on the substrate 1, and the composite material film layer 2 is processed by the ultrafast laser UL to have the surface modification structure 2a.

To verify biological detection capability of the biological detection component 100, the biological detection component 100 of the present embodiment can be verified through a method for evaluating biological detection capability as shown in FIG. 2, which includes step S120.

Step S120 is a detection step that includes dropping a detection liquid Lt onto the surface modification structure 2a of the biological detection component 100 to evaluate biological detection capability of the biological detection component 100. In the present embodiment, the detection step is to detect lactic acid (LA).

The detection liquid Lt is a buffered saline aqueous solution and contains lactic acid at a predetermined molar concentration. In the present embodiment, the buffered saline aqueous solution is phosphate-buffered saline (PBS), and a pH value of the buffered saline aqueous solution is between 7.2 and 7.6 (preferably 7.4). Additionally, the lactic acid is diluted with the buffered saline aqueous solution. The predetermined molar concentration of lactic acid is 2 μM to 10 μM.

In the present embodiment, the detection step can, for example, include preparing a plurality of detection liquids Lt with different predetermined molar concentrations of lactic acid (e.g., 2 μM, 4 μM, 6 μM, 8 μM, and 10 μM), and sequentially dropping the detection liquids Lt with different predetermined molar concentrations of lactic acid onto the surface modification structure 2a at different times in an order from low concentration to high concentration, and observing the change in current over time to evaluate the sensing response and detection sensitivity of the biological detection component 100 for lactic acid.

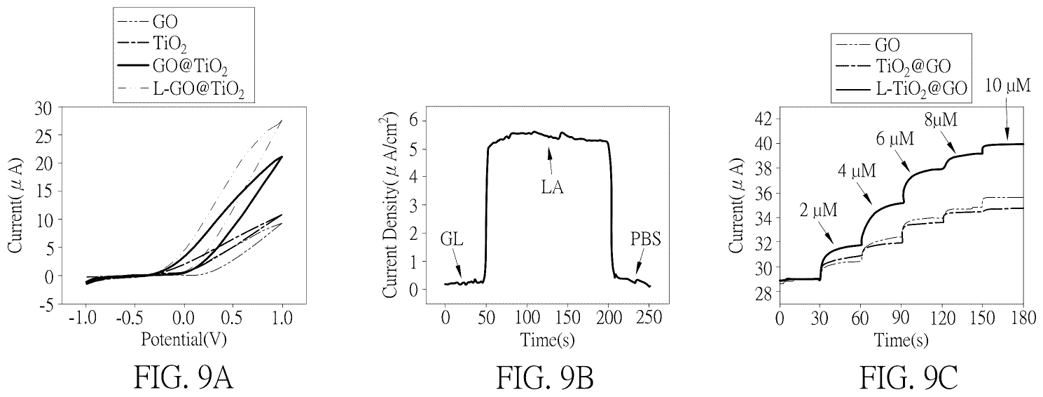

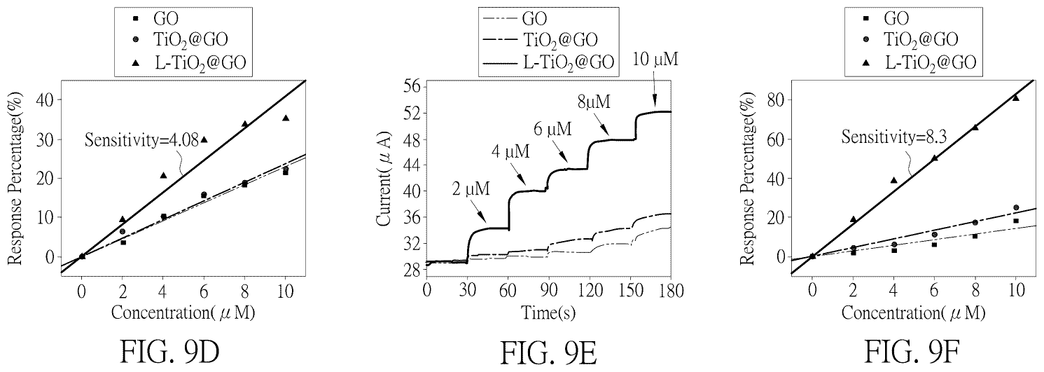

Specifically, the method for evaluating the biological detection capability of the present embodiment adopts a Keithley power supply to set a voltage of 1 V and measures the effect of detection solutions with different lactic acid concentrations on current variations. The method includes preparing lactic acid solutions with different lactic acid concentrations, changing the lactic acid concentration every 30 seconds, and recording the current change. At the start of the experiment, a baseline current is measured, then detection solutions with different lactic acid concentrations are added sequentially, and the current response at each concentration is recorded to generate a graph of current versus time. The effect of different concentrations on the current is analyzed to evaluate sensitivity, response time, and stability of the biological detection component 100, and to determine the detection concentration range of the biological detection component 100. The detection results are shown in FIG. 9A to FIG. 9F. However, the method for detecting the biological detection component 100 in the present disclosure is not limited to the above method.

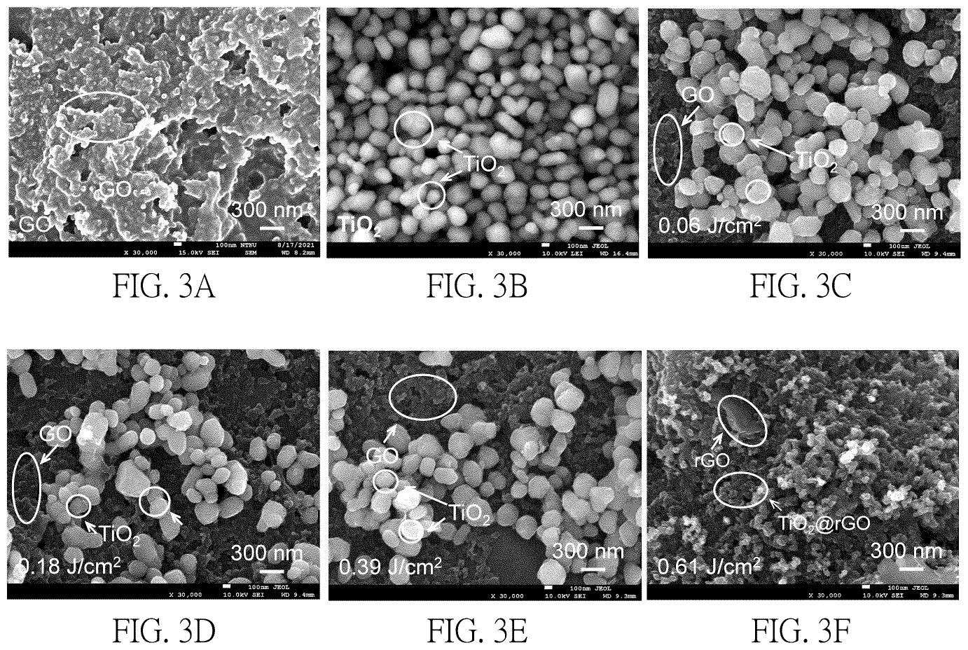

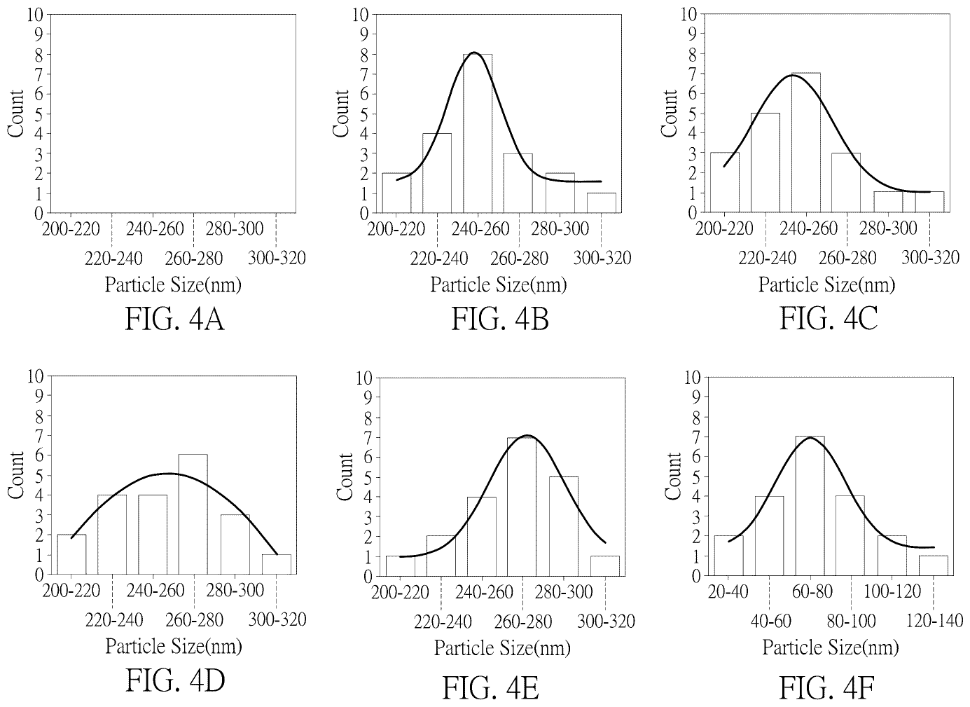

Referring to FIG. 3A to FIG. 3F and FIG. 4A to FIG. 4F, FIG. 3A to FIG. 3F show surface morphology photographs of different materials taken under a scanning electron microscope (SEM). FIG. 3A shows the surface morphology of pure graphene oxide (GO) having lamellar structure (flake structure). FIG. 3B shows the surface morphology of pure titanium dioxide (TiO₂) particles. FIG. 3C shows the surface morphology of the TiO₂@GO composite film layer (i.e., TiO₂ particles distributed on GO flake structure) processed with a laser energy density of 0.06 J/cm². FIG. 3D shows the surface morphology of the TiO₂@GO composite film layer processed with an energy density of 0.18 J/cm². FIG. 3E shows the surface morphology of the TiO₂@GO composite film layer processed with an energy density of 0.39 J/cm². FIG. 3F shows the surface morphology of the TiO₂@GO composite film layer processed with an energy density of 0.61 J/cm² which can produce rGO and TiO₂@rGO. Additionally, FIG. 4A to FIG. 4F show the particle size distribution diagrams of titanium dioxide (TiO₂) particles respectively in FIG. 3A to FIG. 3F.

FIG. 3A shows that the graphene oxide (GO) layer has a lamellar structure (flake structure), and partial folding and undulations on the surface of the GO layer can be observed. Since GO contains a large amount of oxygen-containing functional groups, an energy-dispersive X-ray spectroscopy (EDS) analysis shows that the contents of C and O are 53.68 wt % and 46.32 wt %, respectively (as shown in Table 1 below). FIG. 3B and FIG. 4B show that fine nanoparticles are observed on titanium dioxide (TiO₂); the interface of the titanium dioxide particles is unclear, and agglomeration of the titanium dioxide particles occurs, with an average particle size of about 247 nm. Additionally, the TiO₂ surface is composed of Ti and O elements, which are 44.45 wt % and 55.55 wt %, respectively. FIG. 3C and FIG. 4C shows the TiO₂@GO composite material, where TiO₂ nanoparticles are uniformly distributed on the surface of the GO lamellar structure (flake structure), and an average particle size of the TiO₂ nanoparticles is about 238 nm. After mixing TiO₂ and GO, the elements of C, O, and Ti are 55.06 wt %, 25.43 wt %, and 19.51 wt %, respectively. FIG. 3C to FIG. 3E show that after laser ablation with an energy density of 0.06 to 0.39 J/cm², the TiO₂ nanoparticles are significantly reduced, with an average particle size of about 230 nm, and the surface presents a layered rGO and TiO₂ structure. In terms of component distribution, after laser processing of the TiO₂@GO film, the O and Ti elements decrease with increasing energy, while the C element increases significantly. FIG. 3F is the morphology after laser ablation at an energy density of 0.61 J/cm² on the TiO₂@GO surface; the surface clearly shows rGO and TiO₂. Compared with the TiO₂@GO morphology, the laser-processed L-TiO₂@GO (i.e., TiO₂@rGO) shows smaller grain sizes, with an average particle size between 70 nm to 90 nm (e.g., 78 nm). After laser processing, different morphologies are obtained, and both O and Ti decrease significantly, while the C content increases.

TABLE 1

| Group | C (wt %) | O (wt %) | Ti (wt %) |
|---|---|---|---|
| (A) | 53.68 | 46.32 | 0.00 |
| (B) | 0.00 | 55.55 | 44.45 |
| (C) | 55.06 | 25.43 | 19.51 |
| (D) | 65.89 | 22.16 | 11.95 |
| (E) | 67.54 | 21.13 | 11.33 |
| (F) | 68.32 | 19.87 | 11.80 |

The groups (C) to (F) of Table 1 show that as the energy density increases from 0.06 J/cm² to 0.61 J/cm², the carbon element (C) increases from 55.06 wt % to 68.32 wt %, the oxygen element (O) decreases from 25.43 wt % to 19.87 wt %, and the titanium element (Ti) decreases from 19.51 wt % to 11.80 wt %. The X-ray spectroscopy (EDS) analysis results indicate that increasing the laser energy density reduces the content of titanium dioxide (TiO₂) and reduces graphene oxide to graphene (r-GO).

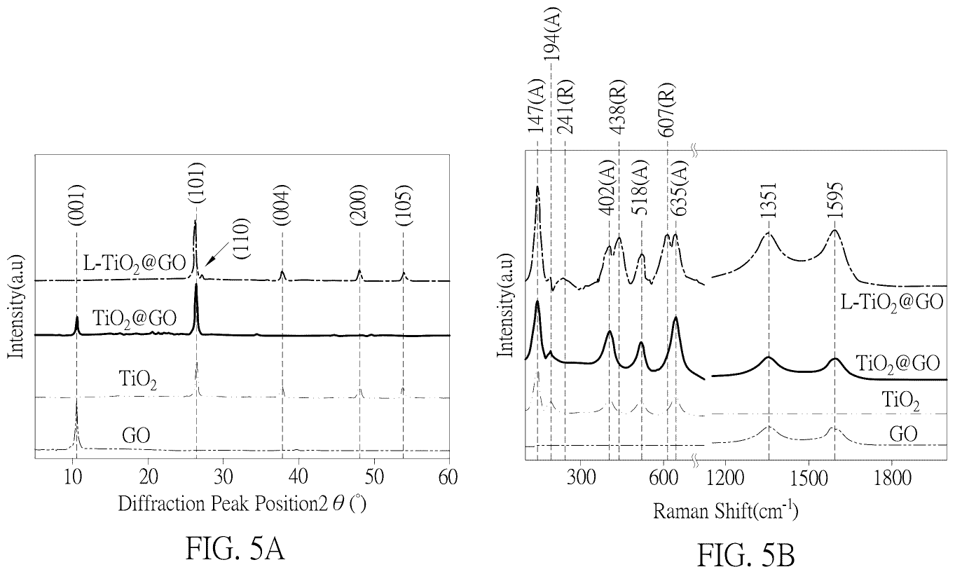

FIG. 5A shows the X-ray diffraction (XRD) spectra of the different materials, and FIG. 5B shows the Raman spectra of the different materials. FIG. 5A shows the crystallinity and lattice orientations of the different materials (e.g., GO, TiO₂, TiO₂@GO, and L-TiO₂@GO) obtained from the XRD spectra. The diffraction peaks of TiO₂ nanoparticles at 2θ angles of 26.4°, 37.8°, 48°, and 53.9° correspond to the (101), (004), (200), and (105) lattice orientations (lattice planes), confirming that the TiO₂ nanoparticles have the anatase phase. In the L-TiO₂@GO nanocomposite processed at 0.61 J/cm², rGO does not exhibit the corresponding characteristic peaks; when GO aqueous solution is mixed with TiO₂ aqueous solution, TiO₂ nanoparticles suppress the characteristic peaks of rGO. Additionally, 2θ shifts to lower angles, changing from 26.45° to 26.2°, and the half-peak width increases from 0.37 to 0.52, which is attributed to changes in grain size due to laser scanning. It is worth noting that L-TiO₂@GO has an obvious peak at 26.2°, corresponding to the (110) lattice orientation (lattice plane), indicating the presence of the rutile phase and the anatase phase.

Raman spectroscopy is used to study the functional groups of GO, TiO₂, TiO₂@GO, and L-TiO₂@GO. The Raman spectrum of GO has two distinct peaks that include D band at 1351 cm⁻¹ and G band at 1595 cm⁻¹, with a defect intensity ratio (ID/IG) of 0.94. In addition to the above peaks, TiO₂@GO has main characteristic peaks at A1g (518 cm⁻¹), B1g (635 cm⁻¹), B1g (402 cm⁻¹), Eg (635 cm⁻¹), Eg (147 cm⁻¹), and Eg (194 cm⁻¹), indicating that TiO₂ presents the anatase phase. Through laser-induced surface modification, the rutile phase intensity in L-TiO₂@GO increases, with corresponding peaks at 607(R), 438(R), and 241(R) cm⁻¹, proving the simultaneous presence of the anatase and the rutile phases. The corresponding peak intensities of the rutile phase at 607(R), 438(R), and 241(R) cm⁻¹ are slightly higher than the adjacent peak intensities corresponding to the anatase phase at 635(A), 402(A), and 194(A) cm⁻¹, indicating that the rutile phase is dominant. That is, the rutile phase is the primary crystal phase, and the anatase phase is the secondary crystal phase.

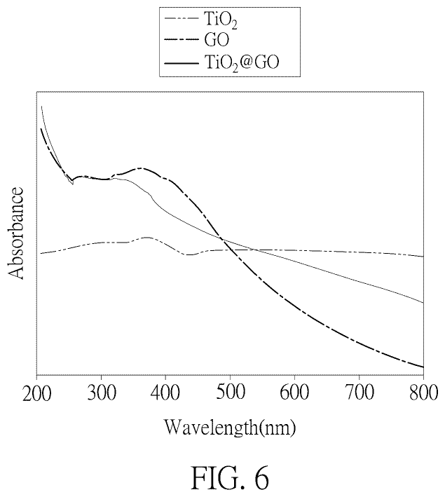

FIG. 6 shows the UV-visible absorption spectra of GO, TiO₂, and GO@TiO₂. Compared with TiO₂ aqueous solution, the absorbance of GO@TiO₂ in the visible light region is significantly enhanced. The 2p orbital energy levels of carbon (C) and oxygen (O) are similar, and the bandgap of TiO₂ narrows due to carbon doping.

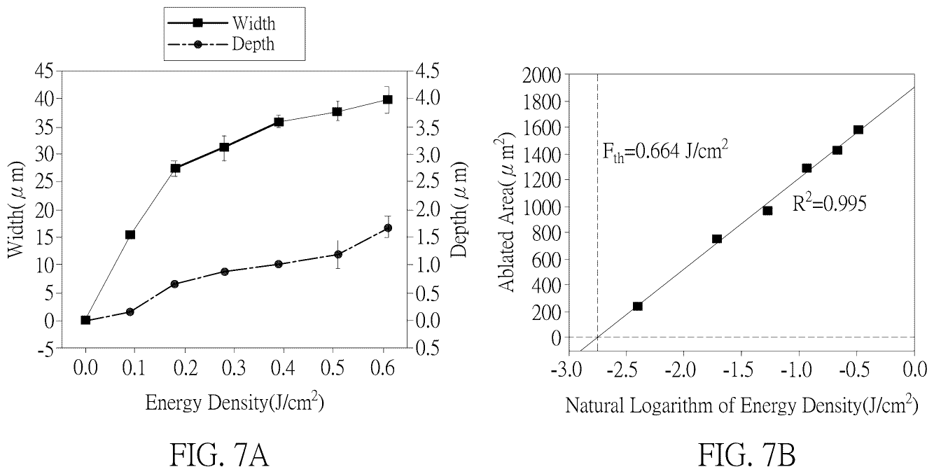

FIG. 7A shows the relationship between the width and depth of direct-written TiO₂@GO composite films at different laser energy densities (J/cm²), evaluated by drawing lines using a femtosecond laser with a wavelength of 1040 nm. The results show that as the energy density increases, the width and depth gradually increase. When the energy density is increased from 0.06 J/cm² to 0.39 J/cm², the width continues to increase. When the energy density is increased from 0.39 J/cm² to 0.61 J/cm², the width tends to level off, with a maximum width of about 39.5 μm. Similarly, as the energy density increases, the depth of the TiO₂@GO composite film gradually increases. When the energy density exceeds 0.61 J/cm², the TiO₂@GO layer is inferred to be ablated from the substrate. Due to the strong light absorption of TiO₂, a lower energy density can cause ablation. By using the spatial intensity distribution of a Gaussian beam, the relationship between the ablation diameter and the critical threshold of MoS₂/rGO films can be derived. The relationship between different energy densities and D² is shown in FIG. 7B. By extrapolating the theoretical straight line, the ablation threshold Fth is obtained as 0.064 J/cm², and the regression analysis R² is 0.995, indicating a high correlation.

### Second Embodiment

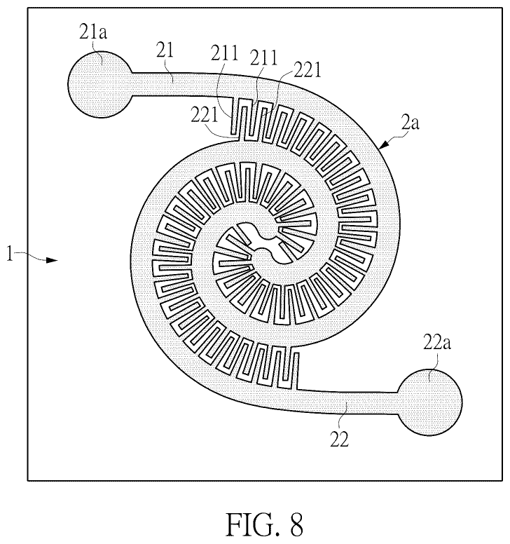

Referring to FIG. 8, a second embodiment of the present disclosure is similar to the first embodiment described above, except that the method for preparing the biological detection component by inducing crystal phase transformation using the ultrafast laser further includes step S140, which is a pattern formation step. The pattern formation step includes at least partially cutting and removing the composite material film layer 2 and the surface modification structure 2a on the substrate 1 using the ultrafast laser UL to form an electrode pattern. In the pattern formation step, the energy density of the ultrafast laser UL is greater than 0.61 J/cm².

The electrode pattern can enhance the response and detection sensitivity of biological detection (e.g., lactic acid detection). The electrode pattern is an interdigitated electrode pattern and partially exposes the surface of the substrate 1. In the present embodiment, the electrode pattern includes a first electrode 21 and a second electrode 22, and each of the first electrode 21 and the second electrode 22 is in a spiral shape. The first electrode 21 has a first electrode terminal 21a, and the second electrode 22 has a second electrode terminal 22a. The first electrode 21 and the second electrode 22 extend from the first electrode terminal 21a and the second electrode terminal 22a, respectively, along a spiral path toward each other. A plurality of first electrode fingers 211 are formed on a first spiral inner sidewall of the first electrode 21, and a plurality of second electrode fingers 221 are formed on a second spiral inner sidewall of the second electrode 22. The plurality of first electrode fingers 211 and the plurality of second electrode fingers 221 are interdigitated with each other and do not contact each other. That is, the plurality of first electrode fingers 211 do not contact the second electrode 22, and the plurality of second electrode fingers 221 do not contact the first electrode 21.

The spiral structure provides a large sensing surface area within a limited space, enhancing sensing efficiency. Furthermore, the surface modification structure 2a (including TiO₂ and rGO) on the surface of the electrode structure further enhances photoelectric performance and stability of the electrodes. The design of the spiral structure is suitable for biological detection components requiring high sensitivity and high stability, such as lactic acid detectors.

FIG. 9A to FIG. 9F show the detection results of the electrochemical properties of the different materials, including evaluating the electrochemical properties of different materials (e.g., GO, TiO₂, TiO₂@GO, L-TiO₂@GO) using cyclic voltammetry (CV). FIG. 9A is CV curves of different materials in 1 M KOH aqueous solution at a scan rate of 200 mVs⁻¹ under steady-state conditions. The CV curves of the materials show enclosed areas and the curves increase with the increase of potential. The L-TiO₂@GO composite material has a significant current response. FIG. 9B shows the detection of LA (lactic acid), GL (glucose), and PBS using the L-TiO₂@GO composite film. The results show that there is no electrical signal response when titrating glucose and PBS. When detecting LA, there is a significant current response, which can be attributed to the non-enzymatic sensor composed of the metal oxide and nanomaterials having a large surface area, capable of carrying a large amount of electroactive substances, and improving the electron and proton transfer processes. By generating current signals through specific reactions with lactic acid, the sensitivity and selectivity of the non-enzymatic sensor are further enhanced, thereby improving the catalytic performance and stability.

The embodiments of the present disclosure involve using different materials to prepare electrode-less resistive lactic acid (LA) sensors and continuously adding lactic acid with concentrations of 2 μM to 10 μM to investigate the response values and sensitivity. FIG. 9C shows the effect of different lactic acid concentrations on the material (e.g., the entire surface of the substrate 1 being covered with the surface modification structure 2a). As the lactic acid concentration increases, the peak current gradually increases. The electro-catalytic oxidation of lactic acid by the electrode can be attributed to the increased lactic acid concentration leading to more electron transfer. FIG. 9D shows the response value and sensitivity of the material. The lactic acid sensor shows linear sensitivity to lactic acid concentrations from 2 μM to 10 μM, with an L-TiO₂@GO response value of 37.9% and sensitivity of 4.08. To verify the effect of the interdigitated electrode pattern (as shown in FIG. 8), in this experiment, resistive LA sensors with interdigitated electrode structures are prepared and the current is changed with titrating different lactic acid concentrations. FIG. 9E shows the effect of different lactic acid concentrations on the material. As the lactic acid concentration increases, the current increases, showing a trend similar to FIG. 9C. When the LA concentration increases to 10 μM, the current of the L-TiO₂@GO composite material is 52.1 μA. FIG. 9F shows the response value and sensitivity of the interdigitated electrode structure. The L-TiO₂@GO has a significantly improved response value and sensitivity, with a response value of 80.68% and a sensitivity of 8.30.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for preparing a biological detection component, comprising:
a film layer formation step that includes forming a composite material film layer on a substrate; wherein the composite material film layer includes graphene oxide and a metal oxide, the metal oxide in the composite material film layer has a first crystal phase, and the first crystal phase is an anatase phase; and
a surface modification step that includes inducing a crystal phase transformation on a surface of the composite material film layer using an ultrafast laser, such that the metal oxide is at least partially transformed to a second crystal phase from the first crystal phase, and the graphene oxide is reduced to reduced graphene oxide, thereby forming a surface modification structure on the substrate to prepare the biological detection component; wherein the second crystal phase is a rutile phase.

2. The method according to claim 1, wherein the substrate is a flexible polymer substrate, and the metal oxide is titanium dioxide.

3. The method according to claim 1, wherein the composite material film layer is formed by:
mixing a first liquid containing the graphene oxide and a second liquid containing the metal oxide to form a mixed liquid;
applying the mixed liquid onto the substrate; and
drying the mixed liquid to form the composite material film layer.

4. The method according to claim 3, wherein, in the film layer formation step, the graphene oxide in the composite material film layer has a continuous lamellar structure formed on the substrate, and the metal oxide is dispersed in granular form on the graphene oxide.

5. The method according to claim 1, wherein, in the surface modification step, the ultrafast laser is a femtosecond laser, and laser processing conditions of the ultrafast laser include: a laser wavelength between 1,030 nm and 1,050 nm, a maximum output power between 11 W and 13 W, and an energy density between 0.50 J/cm² and 0.75 J/cm².

6. The method according to claim 5, wherein the surface modification structure has a p-n heterojunction formed between the reduced graphene oxide and the metal oxide, a conductivity type of the reduced graphene oxide is p-type, and a conductivity type of the metal oxide is n-type.

7. The method according to claim 1, further comprising:
a pattern formation step that includes at least partially cutting and removing the surface modification structure on the substrate using the ultrafast laser to partially expose the substrate, thereby forming an electrode pattern; wherein a surface of the electrode pattern has the surface modification structure.

8. A biological detection component, comprising:
a substrate; and
a surface modification structure formed on the substrate;
wherein the surface modification structure includes a metal oxide and reduced graphene oxide, the metal oxide has a first crystal phase and a second crystal phase, the first crystal phase is an anatase phase, and the second crystal phase is a rutile phase.

9. The biological detection component according to claim 8, wherein the surface modification structure has an electrode pattern, and the electrode pattern partially exposes a surface of the substrate.

10. The biological detection component according to claim 9, wherein the electrode pattern further includes a first electrode and a second electrode, each in a spiral shape, and the first electrode and the second electrode respectively extend along a spiral path toward each other; wherein a plurality of first electrode fingers are formed on a spiral inner sidewall of the first electrode, a plurality of second electrode fingers are formed on a spiral inner sidewall of the second electrode, and the plurality of first electrode fingers and the plurality of second electrode fingers are interdigitated with each other.
